(19) United States
(12) Patent Application Publication
(10) Pub. No.: US 2009/0033899 A1
(43) Pub. Date: Feb. 5, 2009

(54) EXPOSURE APPARATUS, EXPOSURE METHOD, AND METHOD FOR MANUFACTURING DISPLAY PANEL SUBSTRATE

(75) Inventors: Katsuaki Matsuyama, KANAGAWA (JP); Ryohji Nemoto, KANAGAWA (JP); Junichi Mori, KANAGAWA (JP); Ryugo Sato, KANAGAWA (JP); Tomoaki Hayashi, KANAGAWA (JP)

Correspondence Address: J C PATENTS, INC., 4 VENTURE, SUITE 250, IRVINE, CA, 92618, US

(73) Assignee: HITACHI HIGH-TECHNOLOGIES CORPORATION, TOKYO (JP)

(21) Appl. No.: 12/175,233

(22) Filed: Jul. 17, 2008

(30) Foreign Application Priority Data
Jul. 30, 2007 (JP) JP2007-197332

(51) Int. Cl. G03B 27/42; G03B 27/58

(52) U.S. Cl. 355/53; 355/72; 355/77

(57) ABSTRACT

The movable stages carry chucks 10a and 10b and move towards secondary stage bases 11a and 11b and a primary stage base 11, thereby positioning the substrate 1 on the primary stage base 11. Each first laser length-measuring system includes laser sources 31a and 31b, bar mirrors 34a and 34b mounted below X stages 14 of the movable stages, and laser interferometers 32a and 32b disposed at positions deviated from X guide rails 13 on the primary stage base 11, so as to detect positions of the movable stages in X direction. The laser interferometers 32a and 32b will not be influenced by the vibration of the secondary stage bases 11a and 11b. Meanwhile, the measuring distance from the laser interferometers 32a and 32b to the movable stages on the primary stage base 11 is reduced.

### CROSS-REFERENCE TO RELATED APPLICATION

This application claims the priority benefit of Japan application serial no. 2007-197332, filed Jul. 30, 2007. All disclosure of the Japan application is incorporated herein by reference.

### BACKGROUND OF THE INVENTION

1. Field of the Invention

The present invention relates to an exposure apparatus and an exposure method using a proximity mode for exposing a substrate in manufacturing a display panel substrate of a liquid crystal display device and the like, and a method for manufacturing the display panel substrate using the same. More particularly, the present invention relates to an exposure apparatus including a plurality of movable stages, an exposure method, and a method for manufacturing the display panel substrate using the same.

2. Description of Related Art

The thin film transistor (TFT) substrates, color filter substrates, plasma display panel substrates, organic electroluminescence (EL) display panel substrates, and the like of liquid crystal display devices serving as display panels are manufactured by forming patterns on the substrates through a photolithography technology by the use of exposure apparatuses. An exposure apparatus may use a projection mode or a proximity mode. In the projection mode, a pattern of a photomask (referred to as “mask”) is projected onto a substrate by a lens or a mirror. In the proximity mode, the pattern of the mask is transferred to the substrate by setting a small proximity gap between the mask and the substrate. Although the proximity mode has poorer pattern resolution capability than the projection mode, the irradiation optical system has a simple structure and high throughput, and thus is suitable for mass production.

In recent years, in manufacturing of various substrates for display panels, in order to meet the requirements for large-scale and diversification of sizes, large substrates are prepared, such that one or more display panel substrates may be manufactured from one substrate according to the sizes of the display panels. In this case, if the proximity mode is adopted, a mask of the same size as the substrate is required to expose one side of the substrate at one time. The cost of the expensive mask is further increased. Therefore, at present, the following mode becomes the mainstream. In this mode, a mask that is smaller than the substrate is used, the substrate is moved step by step by a movable stage in X, Y directions, and at the same time, one side of the substrate is divided into a plurality of shot areas for exposure. Hereinafter, this mode is referred to as a proximity XY step mode.

Japanese Patent Laid-open Application No. 2005-331542 discloses a technique of using a laser length-measuring system in a proximity XY step mode exposure to position, with high precision, a substrate, so as to improve the exposure precision. The laser length-measuring system includes a light source, a reflection mirror (bar mirror), and a laser interferometer. The light source is used for generating a laser. The reflection mirror is mounted on a chuck. The laser interferometer measures the interference of the laser from the light source and a laser reflected by the reflection mirror (bar mirror). In addition, Japanese Patent Laid-open Application No. 2005-140935 also discloses a technique in a proximity mode exposure of using a plurality of chucks for holding a substrate and a plurality of movable stages for moving the chucks to increase the throughput. Especially, in a proximity XY step mode exposure, the throughput is significantly improved.

As described in Japanese Patent Laid-open Application No. 2005-140935, when a plurality of chucks and a plurality of movable stages are used for delivery, a stage base for moving the movable stages between an load/unload position and an exposure position of a substrate is separated into a secondary stage base for defining the load/unload position and a primary stage base for defining the exposure position. Moreover, in order to use a laser length-measuring system as described in Japanese Patent Laid-open Application No. 2005-331542 to position the substrate during the exposure, a laser interferometer of the laser length-measuring system must be disposed on the secondary stage base or the primary stage base.

If the laser interferometer of the laser length-measuring system is disposed on the secondary stage base, the laser interferometer will be influenced by the vibration of the secondary stage base. The measuring distance from the laser interferometer to the movable stages on the primary stage base will increase. Thus, measurement errors may easily occur. On the other hand, if the laser interferometer of the laser length-measuring system is disposed on the primary stage base, the movable stages when moving between the secondary stage base and the primary stage base will collide with the laser interferometer. Thus, the laser interferometer must be moved. However, once the laser interferometer is moved, the reproducibility of measurement result may become a problem.

### SUMMARY OF THE INVENTION

Accordingly, the present invention is directed to using a laser length-measuring system in a proximity mode exposure, and a plurality of movable stages are used to position, with high precision, a substrate during the exposure.

In addition, other purpose of the present invention is to perform, with high precision, the expose of a pattern.

The present invention is characterized in that a primary stage base is arranged below a mask holder for holding a mask; a plurality of secondary stage bases is arranged adjacent to one another in X direction (or Y direction) of the primary stage base; guide rails extending from the primary stage base to the plurality of secondary stage bases are disposed; a plurality of movable stages each including a first stage, a second stage, and a third stage is disposed, the first stages are carried on the guide rails and move in X direction (or Y direction), the second stages are carried on the first stages and move in Y direction (or X direction), the third stages are carried on the second stages and rotate in θ direction, and the plurality of movable stages carry chucks for holding substrates; the movable stages move towards one secondary stage base and the primary stage base; the substrates on the primary stage base are positioned by the movable stages; a plurality of first laser length-measuring systems each including a light source, a reflection mirror, and a laser interferometer is used, the light sources are used for generating lasers, the reflection mirror are mounted on the movable stages, the laser interferometers measure the interference of a laser from a light source and a laser reflected by the reflection mirrors, the reflection mirrors are mounted below the first stages of the movable stages respectively; the laser interferometers are disposed at positions deviated from the guide rails on the primary stage base so as to detect positions of the movable stages in X direction (or Y direction); and the substrate positioning performed by the movable stages is controlled according to a detection result.

Since the guide rails extending from the primary stage base to the plurality of secondary stage bases are disposed and the first stages of the movable stages are carried on the guide rails, a space corresponding to the height of the guide rails is generated between the primary and secondary stage bases and the first stage of each movable stage. Since the reflection mirrors of the first laser length-measuring systems for detecting positions of the movable stages in X direction (or Y direction) are mounted below the first stages of the movable stages respectively and the laser interferometers are disposed at positions deviated from the guide rails on the primary stage base, thus, the movable stages will not collide with the laser interferometers when the secondary stage bases and the primary stage base are moved. In addition, since the laser interferometers are disposed on the primary stage base, the laser interferometers will not be influenced by the vibration of the secondary stage bases. Moreover, the measuring distance from the laser interferometers to the movable stages on the primary stage base is reduced. Therefore, the first laser length-measuring systems can be used to detect, with high precision, the positions of the movable stages in X direction (or Y direction).

Other feature of the present invention is that, in each first laser length-measuring system, a plurality of laser interferometers are disposed at positions deviated from the guide rails on the primary stage base. Since in each first laser length-measuring system, the plurality of laser interferometers is disposed on the primary stage base, the yawing of the first stages of the movable stages when moving in X direction (or Y direction) can be detected according to the measurement results of the plurality of laser interferometers. Therefore, the positions of the substrates in X direction (or Y direction) during exposure can be decided more precisely.

Other feature of the present invention is that, a stage is mounted in Y direction (or X direction) of the primary stage base, and a second laser length-measuring system is used, the second laser length-measuring system includes a light source for generating a laser, reflection mirrors mounted on the movable stages, and a laser interferometer to measure interference of the laser from the light source and a laser reflected by the reflection mirrors; the reflection mechanisms are mounted on the second stages of the movable stages; the laser interferometer is disposed on the stage so as to detect positions of the movable stages in Y direction (or X direction) on the primary stage base; the substrate positioning performed by the movable stages is controlled according to a detection result.

Since the laser interferometer of the second laser length-measuring system is disposed on the stage, the second laser length-measuring system is used for detecting the positions of the movable stages in Y direction (or X direction) on the primary stage base, and the stage is mounted in Y direction (or X direction) of the primary stage base, the laser interferometer will not be influenced by the vibration of the secondary stage bases. Moreover, the measuring distance from the laser interferometer to the movable stages on the primary stage base is reduced. Therefore, the second laser length-measuring system can be used to detect, with high precision, the positions in Y direction (or X direction) of the movable stages on the primary stage bases. Therefore, the positions of the substrates in Y direction (or X direction) during exposure can be decided precisely.

Other feature of the present invention is that, the reflection mirrors of the second laser length-measuring system are mounted substantially at a height of the chucks carried by the movable stages. Also, the reflection mirrors of the second laser length-measuring system are mounted substantially at a height of the chucks carried by the movable stages, thus the positions of the movable stages in Y direction (or X direction) can be detected in the vicinity of the substrates. Therefore, the positions of the substrates in Y direction (or X direction) during exposure can be decided more precisely.

Other feature of the present invention is that, the reflection mechanisms are mounted on the chucks; the laser displacement meters are used for measuring displacements of the reflection mechanisms, so as to detect the tilt of the chucks in θ direction; the substrate positioning performed by the movable stages is controlled according to a detection result. Since the reflection mirrors are mounted on the chucks and the plurality of laser displacement meters is used to measure the displacements of the reflection mirrors, respectively, the tilt of the chucks in θ direction can be detected with high precision. Therefore, the positions of the substrates in θ direction during exposure can be decided precisely.

Other feature of the present invention is that, a plurality of laser displacement meters is disposed on the first stages of the movable stages. In addition, a plurality of laser displacement meters is disposed on the first stages of the movable stages, thus the yawing of the second stages carried on the first stages when moving in Y direction (or X direction) can be detected according to measurement results of the several laser displacement meters. Therefore, the positions of the substrates in Y direction (or X direction) during exposure can be decided more precisely.

The exposure apparatus or exposure method of the present invention is adopted to expose a substrate. Since the substrate can be positioned with high precision during the exposure, the pattern can be exposed with high precision, and thus a high quality substrate can be manufactured.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating an exposure apparatus according to an embodiment of the present invention.

FIG. 2 is a top view illustrating a status that a chuck 10a is at an exposure position and a chuck 10b is at a load/unload position.

FIG. 3 is a local sectional side view illustrating a status that the chuck 10a is at the exposure position and the chuck 10b is at the load/unload position.

FIG. 4 is a top view illustrating a status that the chuck 10b is at an exposure position and the chuck 10a is at a load/unload position.

FIG. 5 is a local sectional side view illustrating a status that the chuck 10b is at the exposure position and the chuck 10a is at the load/unload position.

FIG. 6 is a top view of movable stages on a primary stage base.

FIG. 7 is a local sectional side view of the movable stages in X direction on the primary stage base.

FIG. 8 is a side view of the movable stages in Y direction on the primary stage base.

FIG. 9 is a diagram illustrating actions of a laser interferometer.

FIG. 10 is a diagram illustrating actions of a laser interferometer.

FIG. 11 is a three-dimensional view of laser displacement meters when measuring displacements in X direction.

FIG. 12 is a three-dimensional view of a laser displacement meter when measuring a displacement in Y direction.

FIG. 13 is a flow chart of steps for manufacturing TFT substrates of liquid crystal display devices according to an embodiment of the present invention.

FIG. 14 is a flow chart of steps for manufacturing color filter substrates of liquid crystal display devices according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

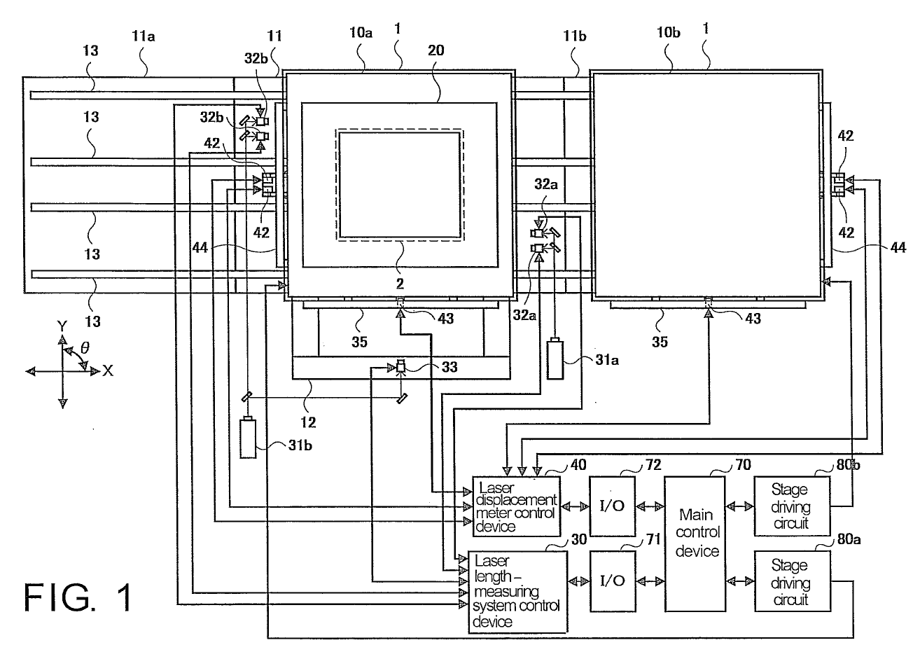

FIG. 1 is a schematic view of an exposure apparatus according to an embodiment of the present invention. Referring to FIG. 1, the exposure apparatus includes a plurality of chucks 10a and 10b, a primary stage base 11, a plurality of secondary stage bases 11a and 11b, a stage 12, X guide rails 13, a plurality of movable stages, a mask holder 20, a laser length-measuring system control device 30, a plurality of first laser length-measuring systems, a second laser length-measuring system, a laser displacement meter control device 40, laser displacement meters 42 and 43, bar mirrors 44 and 45, a main control device 70, input/output interface circuits 71 and 72, and stage driving circuits 80a and 80b. In addition to the parts described above, the exposure apparatus also includes an irradiation optical system for irradiating exposure lights, carry-in units for carrying in substrates 1, carry-out units for carrying out the substrates 1, a temperature control unit for managing the temperature inside the apparatus, etc.

In addition, in the embodiment, the numbers of the chucks, secondary stage bases, movable stages, first laser length-measuring systems, and stage driving circuits are all set to be two. However, the numbers of these parts can also be set to be three or more. Moreover, the X, Y directions are exemplary in the embodiment, and the X direction and the Y direction may also be exchanged.

In FIG. 1, the mask holder 20 for holding a mask 2 is disposed above an exposure position for exposing the substrates 1. The mask holder 20 holds the periphery of the mask 2 in this manner of vacuum absorption. An irradiation optical system (not shown) is arranged above the mask 2 held by the mask holder 20. During exposure, the exposure lights from the irradiation optical system are irradiated on the substrates 1 after passing through the mask 2, and thus a pattern of the mask 2 is transferred to the surfaces of the substrates 1, and thus the patterns are formed on substrates 1.

The primary stage base 11 is arranged below the mask holder 20. On the left and right sides of the primary stage base 11, the secondary stage bases 11a and 11b are arranged adjacent to one another in X direction of the primary stage base 11. The stage 12 is mounted in Y direction of the primary stage base 11. The chuck 10a is forced by the movable stages described below to move between a load/unload position of the secondary stage base 11a and an exposure position of the primary stage base 11. In addition, the chuck 10b is forced by the movable stages described below to move between a load/unload position of the secondary stage base 11b and the exposure position of the primary stage base 11. At the load/unload positions of the secondary stage bases 11a and 11b, the substrates 1 are carried onto the chucks 10a and 10b by means of the carry-in units (not shown) and are taken back from the chucks 10a and 10b by means of the carry-out units (not shown). The chucks 10a and 10b hold the substrates 1 in this manner of vacuum absorption.

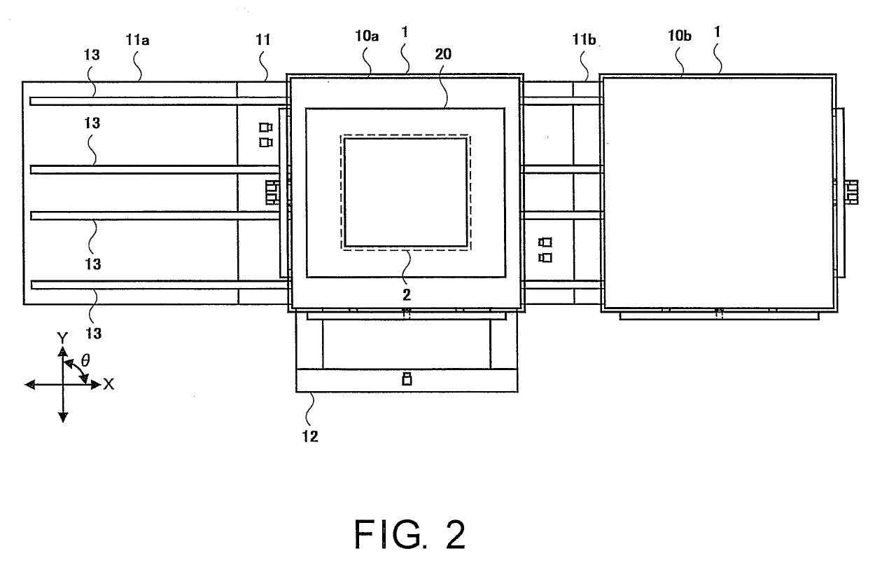

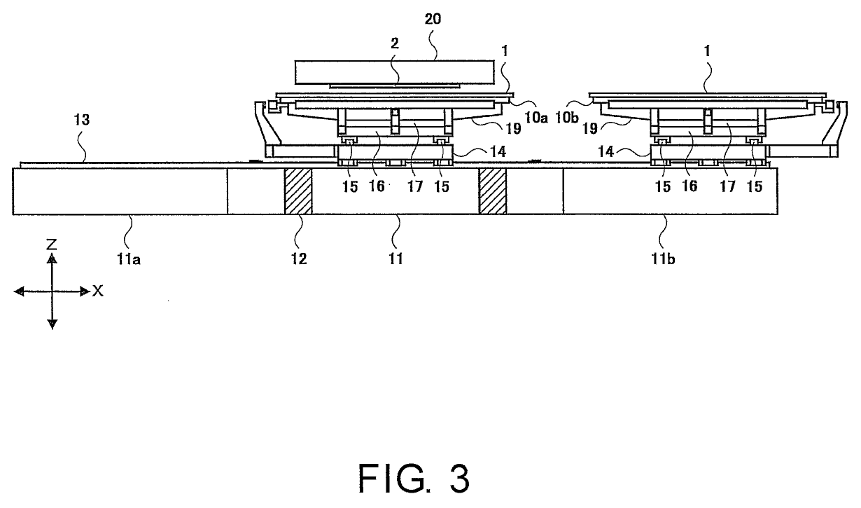

FIG. 2 is a top view illustrating a status that the chuck 10a is at an exposure position and the chuck 10b is at a load/unload position, and FIG. 3 is a local sectional side view illustrating a status that the chuck 10a is at the exposure position and the chuck 10b is at the load/unload position. Referring to FIG. 2, X guide rails 13 extending from the primary stage base 11 to the secondary stage bases 11a and 11b in X direction are disposed on the primary stage base 11 and the secondary stage bases 11a and 11b.

Referring to FIG. 3, the chucks 10a and 10b are respectively carried on the movable stages. Each movable stage includes an X stage 14, Y guide rails 15, a Y stage 16, a θ stage 17, and a chuck supporting stage 19. The X stage 14 is carried on the X guide rails 13 and moves along the X guide rails 13 in X direction. The Y stage 16 is carried on the Y guide rails 15 disposed on the X stage 14 and moves along the Y guide rails 15 in Y direction (the depth direction in the figure). The θ stage 17 is carried on the Y stage 16 and rotates in θ direction. The chuck supporting stage 19 is carried on the θ stage 17 so as to support the chucks 10a and 10b.

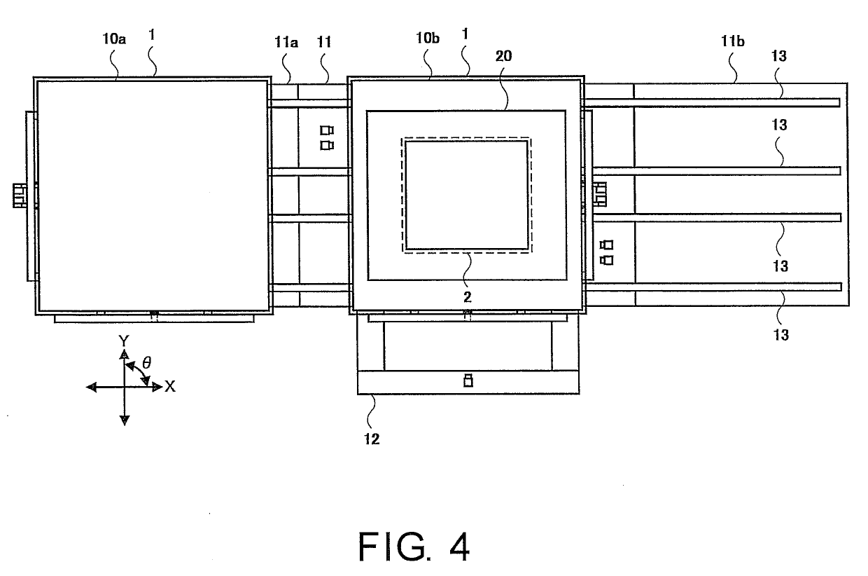

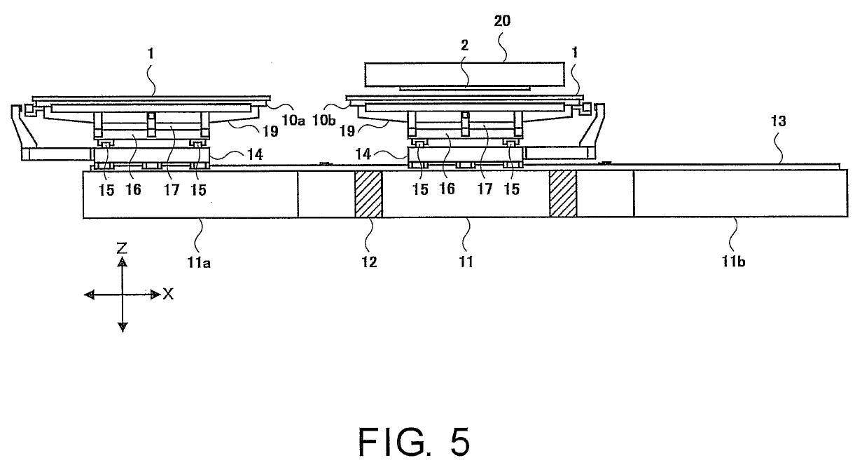

Through the movement of the X stages 14 of the movable stages in X direction, the chuck 10a moves between the load/unload position of the secondary stage base 11a and an exposure position of the primary stage base 11, and the chuck 10b moves between the load/unload position of the secondary stage base 11b and the exposure position of the primary stage base 11. FIG. 4 is a top view illustrating a status that the chuck 10b is at an exposure position and the chuck 10a is at a load/unload position. FIG. 5 is a local sectional side view illustrating the state that the chuck 10b is at the exposure position and the chuck 10a is at the load/unload position.

At the exposure position on the primary stage base 11, the substrates 1 held on the chucks 10a and 10b move step by step in the X, Y directions through the movement of the X stages 14 of the movable stages in X direction and the movement of the Y stages 16 in Y direction. The substrates 1 are positioned during the exposure through the movement of the X stages 14 of the movable stages in X direction, the movement of the Y stages 16 in Y direction, and the rotation of the θ stages 17 in θ direction. Furthermore, the mask holder 20 moves and tilts in Z direction by a Z-tilt mechanism (not shown), thereby closing gaps between the mask 2 and the substrates 1. As shown in FIG. 1, the stage driving circuit 80a is controlled by the main control device 70 to drive the X stage 14, the Y stage 16, and the θ stage 17 of the movable stage carrying the chuck 10a. The stage driving circuit 80b is controlled by the main control device 70 to drive the X stage 14, the Y stage 16, and the θ stage 17 of the movable stage carrying the chuck 10b.

In addition, in this embodiment, the gaps between the mask 2 and the substrates 1 are closed by the movement and tilt of the mask holder 20 in Z direction. However, the gaps between the mask 2 and the substrates 1 can also be closed by setting Z-tilt mechanisms on the movable stages to move and tilt the chucks 10a and 10b in Z direction.

Hereinafter, the positioning of the substrates performed by the exposure apparatus according to the embodiment is illustrated. In the embodiment, one of the two first laser length-measuring systems is used to detect the position of the movable stage carrying the chuck 10a in X direction, and the other is used to detect the position of the movable stage carrying the chuck 10b in X direction. The second laser length-measuring system is used to detect the positions of the movable stages on the primary stage base 11 in Y direction. Then, the laser displacement meters 42 and 43 are used to detect the tilt of the chucks 10a and 10b in θ direction.

As shown in FIG. 1, one first laser length-measuring system includes a laser source 31a, two laser interferometers 32a, and a bar mirror 34a described below. The other first laser length-measuring system includes a laser source 31b, two laser interferometers 32b, and a bar mirror 34b described below. Meanwhile, the second laser length-measuring system includes the laser source 31b, a laser interferometer 33, and bar mirrors 35.

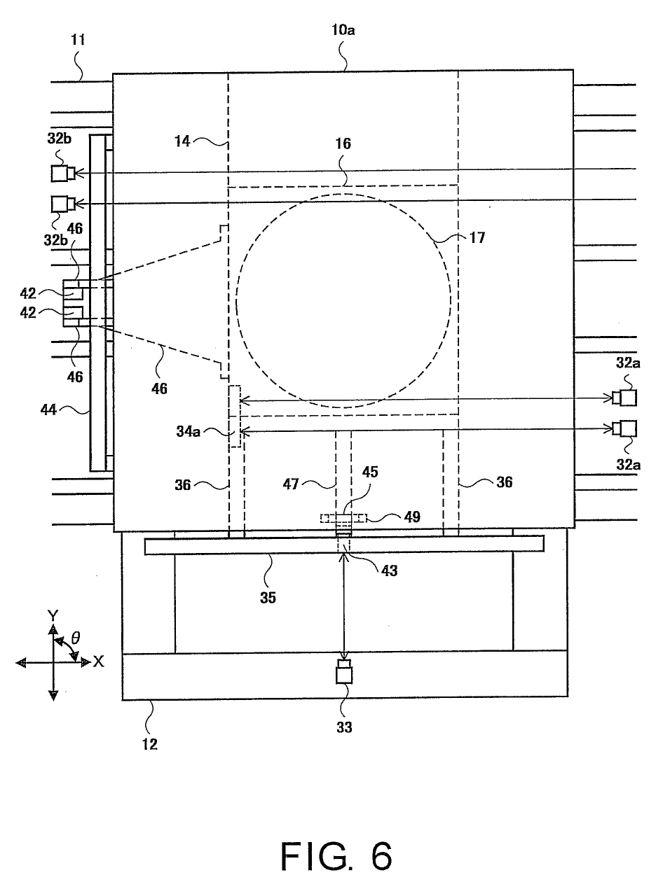

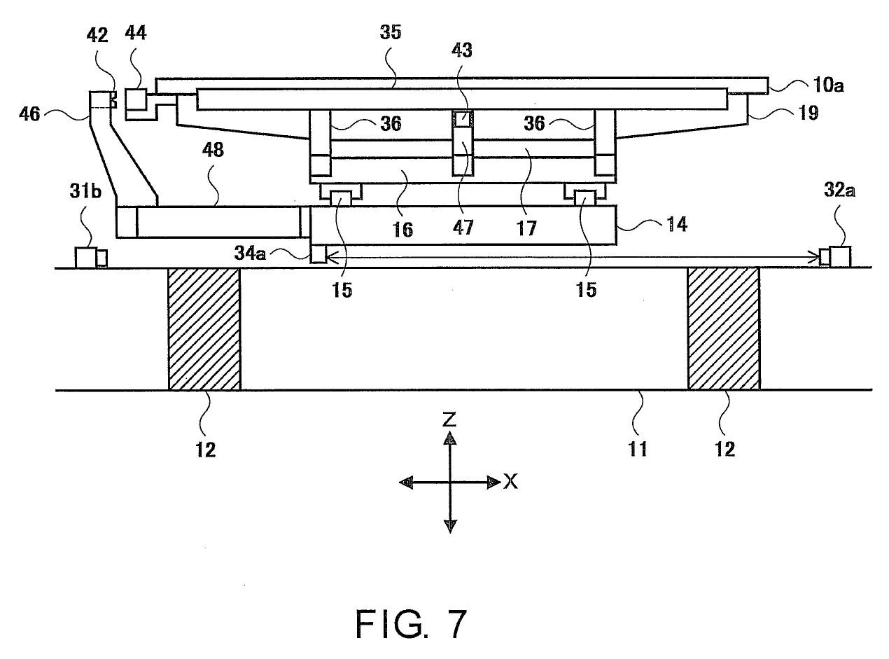

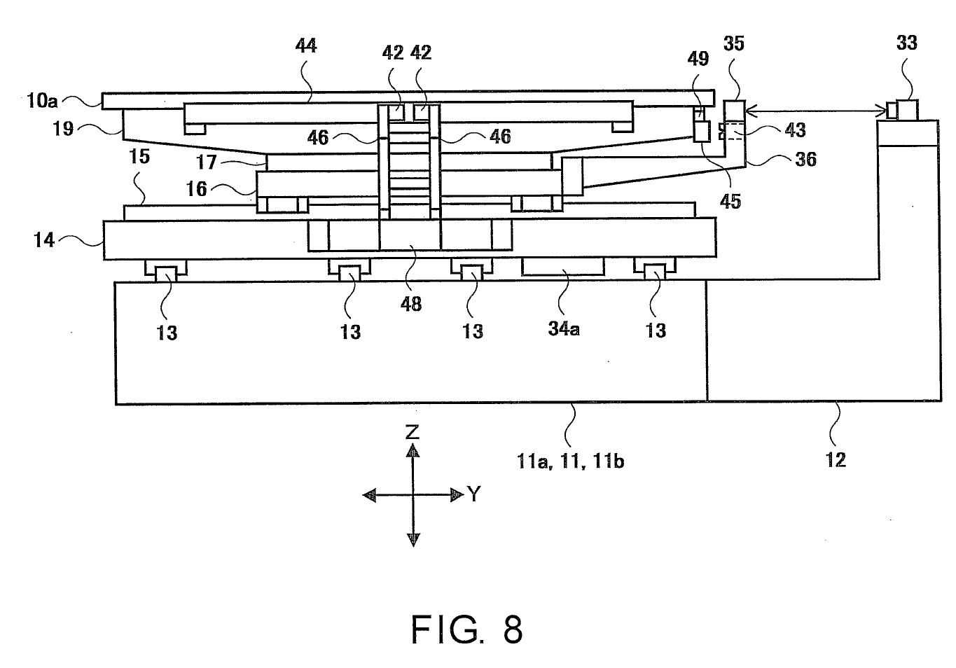

FIG. 6 is a top view of movable stages on a primary stage base. FIG. 7 is a local sectional side view of the movable stages in X direction on the primary stage base. FIG. 8 is a side view of the movable stages in Y direction on the primary stage base. FIGS. 6˜8 show the movable stage carrying the chuck 10a which is symmetrical to the movable stage carrying the chuck 10b in X direction. In addition, the X guide rails 13 are omitted in FIG. 7, and the laser interferometers 32a and 32b are omitted in FIG. 8.

As shown in FIG. 8, since the X stages 14 of the movable stages are carried on the X guide rails 13, a space corresponding to the height of the X guide rails 13 is generated between the primary stage base 11 and secondary stage bases 11a and 11b and the X stages 14. The bar mirror 34a of the first laser length-measuring system is mounted below the X stages 14 by using the space. The bar mirror 34b is mounted in the same manner. As shown in FIG. 1, the two laser interferometers 32a of the first laser length-measuring systems are disposed at positions deviated from the X guide rails 13 on the primary stage base 11. The laser interferometers 32b are disposed in the same manner.

As shown in FIGS. 6-8, the bar mirrors 35 of the second laser length-measuring system are mounted on the Y stage 16 approximately at the height of the chuck 10a by the use of a support arm 36. Likewise, for the movable stage carrying the chuck 10b, the bar mirrors 35 are mounted on the Y stage 16 approximately at the height of the chuck 10b. As shown in FIG. 6 and FIG. 8, the laser interferometer 33 of the second laser length-measuring system is disposed on the stage 12 mounted in Y direction of the primary stage base 11.

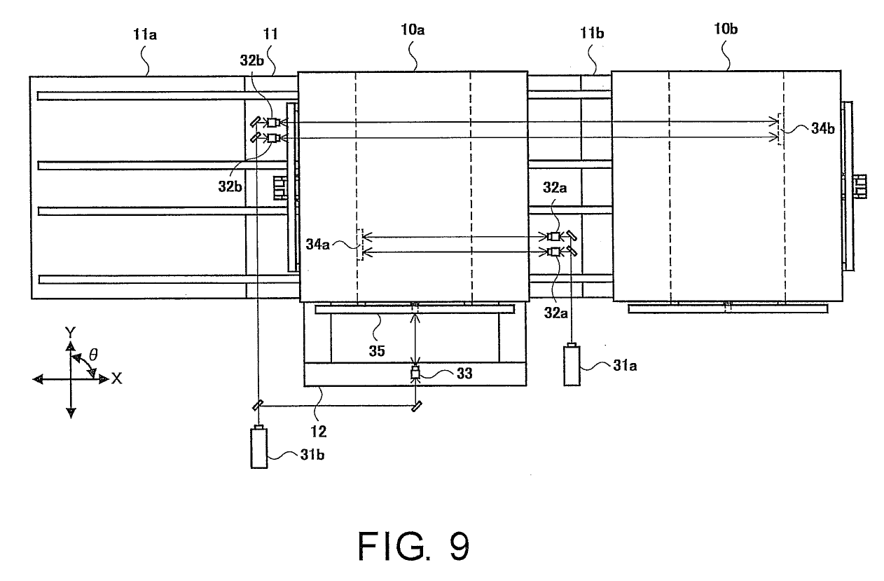

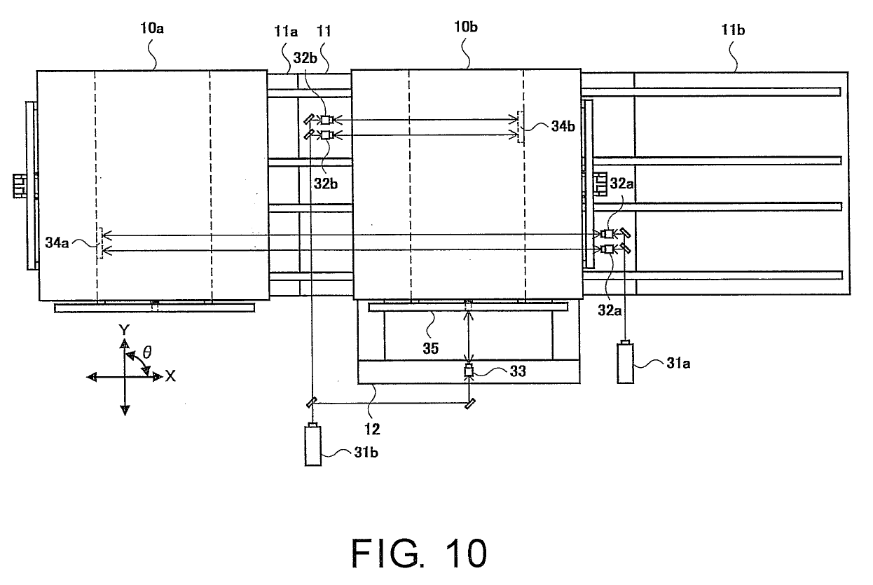

FIGS. 9 and 10 are diagrams showing actions of a laser interferometer. FIG. 9 shows a status that the chuck 10a is at the exposure position and the chuck 10b is at the load/unload position, and FIG. 10 shows a status that the chuck 10b is at the exposure position and the chuck 10a is at the load/unload position.

As shown in FIGS. 9 and 10, the laser interferometers 32a make a laser from the laser source 31a irradiated on the bar mirror 34a, and receives a laser reflected by the bar mirror 34a, thereby measuring the interference of the laser from the laser source 31a and the laser reflected by the bar mirror 34a. As shown in FIG. 1, the laser length-measuring system control device 30 is controlled by the main control device 70 to detect the position of the movable stage carrying the chuck 10a in X direction and the yawing of the X stages 14 when moving in X direction according to measurement results of the two laser interferometers 32a.

As shown in FIGS. 9 and 10, the laser interferometers 32b make a laser from the laser source 31b irradiated on the bar mirror 34b, and receives a laser reflected by the bar mirror 34b, thereby measuring the interference of the laser from the laser source 31b and the laser reflected by the bar mirror 34b. As shown in FIG. 1, the laser length-measuring system control device 30 is controlled by the main control device 70 to detect the position of the movable stage carrying the chuck 10b in X direction and the yawing of the X stages 14 when moving in X direction according to measurement results of the two laser interferometers 32b.

Since the bar mirrors 34a and 34b of the first laser length-measuring systems are mounted below the X stages 14 of the movable stages, and the laser interferometers 32a and 32b are disposed at positions deviated from the X guide rails 13 on the primary stage base 11, the movable stages will not collide with the laser interferometers 32a and 32b when the secondary stage bases 11a and 11b and the primary stage base 11 are moved. In addition, since the laser interferometers 32a and 32b are disposed on the primary stage base 11, the laser interferometers 32a and 32b will not be influenced by the vibration of the secondary stage bases 11a and 11b. Moreover, the measuring distance from the laser interferometers 32a and 32b to the movable stages on the primary stage base 11 is reduced. Therefore, the first laser length-measuring systems can be used to detect, with high precision, the positions of the movable stages in X direction. In addition, since in each first laser length-measuring system, a plurality of laser interferometers 32a and 32b is disposed on the primary stage base 11, the yawing of the X stages 14 of the movable stages when moving in X direction can be detected with high precision according to measurement results of the laser interferometers 32a and 32b.

As shown in FIGS. 9 and 10, the laser interferometer 33 makes a laser from the laser source 31b irradiated on the bar mirror 35, and receives a laser reflected by the bar mirror 35, thereby measuring the interference of the laser from the laser source 31b and the laser reflected by the bar mirror 35. As shown in FIG. 1, the laser length-measuring system control device 30 is controlled by the main control device 70 to detect the positions of the movable stages on the primary stage base 11 in Y direction according to a measurement result of the laser interferometer 33.

Since the laser interferometer 33 of the second laser length-measuring system is disposed on the stage 12 mounted in Y direction of the primary stage base 11, the laser interferometer 33 will not be influenced by the vibration of the secondary stage bases 11a and 11b. Moreover, the measuring distance from the laser interferometer 33 to the movable stages on the primary stage base 11 is reduced. Therefore, the second laser length-measuring system can be used to detect, with high precision, the positions of the movable stages on the primary stage base 11 in Y direction. In addition, since the bar mirrors 35 of the second laser length-measuring system are mounted substantially at a height of the chucks 10a and 10b carried by the movable stages, the positions of the movable stages in Y direction can be detected in the vicinity of the substrates 1.

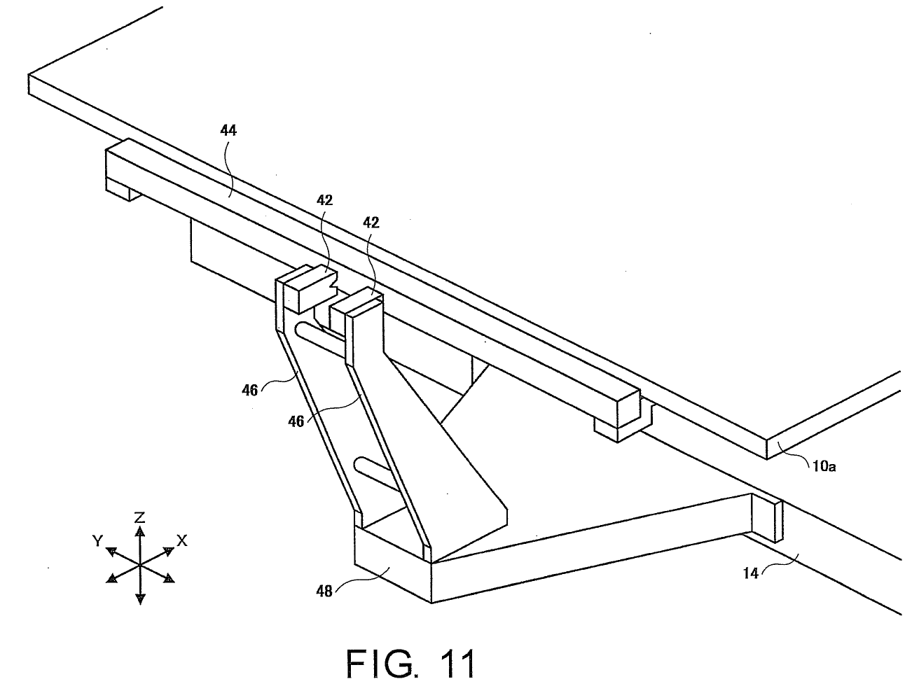

FIG. 11 is a three-dimensional view of laser displacement meters measuring displacements in X direction. In FIG. 11, the laser displacement meter mounted on the movable stage carrying the chuck 10a is symmetrical to the laser displacement meter mounted on the movable stage carrying the chuck 10b in X direction. The bar mirrors 44 are mounted on the side in Y direction of the chucks 10a and 10b. The two laser displacement meters 42 are mounted on a block 48 at the height of the bar mirrors 44 respectively by the use of support arms 46. The block 48 is mounted on the X stage 14.

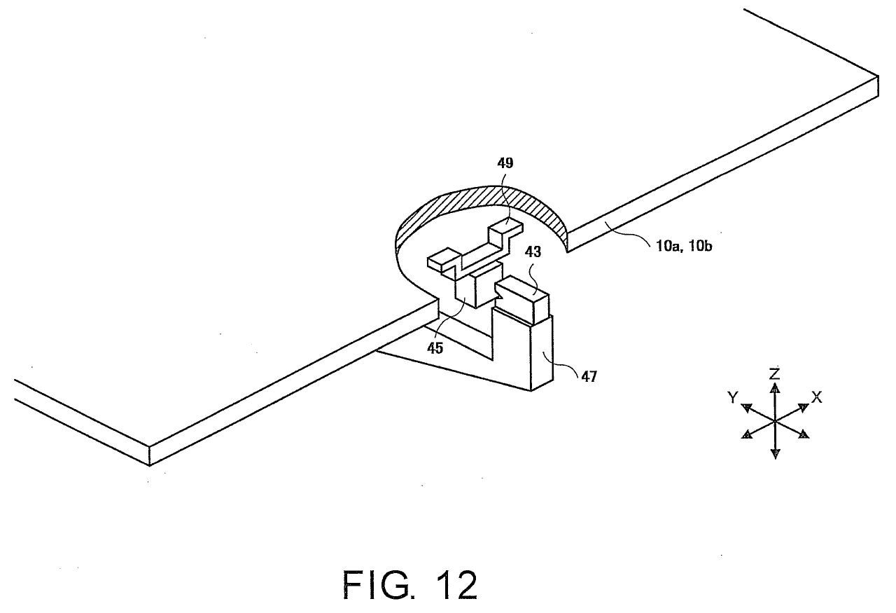

FIG. 12 is a three-dimensional view of a laser displacement meter measuring a displacement in Y direction. Referring to FIG. 12, a bar mirror 45 is mounted on a back side of the chucks 10a and 10b by the use of a mounting piece 49. As shown in FIGS. 7 and 12, the laser displacement meter 43 is mounted on the Y stage 16 at the height of the bar mirror 45 by the use of a support arm 47. In addition, in FIG. 12, parts of the chucks 10a and 10b are removed in order to observe the bar mirror 45 and the mounting piece 49.

As shown in FIG. 11, each laser displacement meter 42 makes a laser irradiated on the bar mirrors 44 and detects a laser reflected by the bar mirrors 44, thereby measuring the displacements of the bar mirrors 44 in X direction. In addition, in FIG. 12, the laser displacement meter 43 makes a laser irradiated on the bar mirror 45 and detects a laser reflected by the bar mirror 45, thereby measuring the displacement of the bar mirror 45 in Y direction. As shown in FIG. 1, the laser displacement meter control device 40 is controlled by the main control device 70 to detect the tilt of the chucks 10a and 10b in θ direction and the yawing of the Y stage 16 when moving in the Y, X directions according to measurement results of the two laser displacement meters 42 and the laser displacement meter 43.

Since the bar mirrors 44 are mounted on the chucks 10a and 10b and a plurality of laser displacement meters 42 is used to measure the displacements of the bar mirrors 44, respectively, the tilt of the chucks 10a and 10b in θ direction can be detected with high precision. In addition, since the plurality of laser displacement meters 42 is disposed on the X stage 14 of the movable stage, the yawing of the Y stage 16 carried on the X stage 14 when moving in Y direction can be detected according to measurement results of the laser displacement meters 42.

As shown in FIG. 1, the main control device 70 inputs a detection result of the laser length-measuring system control device 30 through the input/output interface circuit 71. The main control device 70 also inputs a detection result of the laser displacement meter control device 40 through the input/output interface circuit 72. Then, the main control device 70 controls the stage driving circuits 80a and 80b to drive the movable stages and positions the substrates 1 during the exposure according to the detection results of the laser length-measuring system control device 30 and the laser displacement meter control device 40.

As described in the above embodiments, the first laser length-measuring systems can be used to detect, with high precision, the positions of the movable stages in X direction. Therefore, the substrates 1 can be positioned with higher precision in X direction during the exposure.

Further, as described in the above embodiments, since in each first laser length-measuring system, the plurality of laser interferometers 32a and 32b is disposed on the primary stage base 11, the yawing of the X stages 14 of the movable stages when moving in X direction can be detected according to the measurement results of the laser interferometers 32a and 32b. Therefore, the substrates 1 can be positioned with higher precision in X direction during the exposure.

Further, as described in the above embodiments, the second laser length-measuring system is used to detect, with high precision, the positions of the movable stages on the primary stage base 11 in Y direction. Therefore, the substrates 1 can be positioned with high precision in Y direction during the exposure.

Further, as described in the above embodiments, since the bar mirrors 35 of the second laser length-measuring system are mounted substantially at a height of the chucks 10a and 10b carried by the movable stages, the positions of the movable stages in Y direction can be detected in the vicinity of the substrates 1. Therefore, the substrates 1 can be positioned with higher precision in Y direction during the exposure.

Further, as described in the above embodiments, since the bar mirrors 44 are mounted on the chucks 10a and 10b and the plurality of laser displacement meters 42 is used to measure the displacements of the bar mirrors 44, respectively, the tilt of the chucks 10a and 10b in θ direction can be detected with high precision. Therefore, the substrates 1 can be positioned with high precision in θ direction during the exposure.

Further, as described in the above embodiments, since the plurality of laser displacement meters 42 is disposed on the X stages 14 of the movable stages, the yawing of the Y stages 16 carried on the X stages 14 when moving in Y direction can be detected according to the measurement results of the plurality of laser displacement meters 42. Therefore, the substrates 1 can be positioned with higher precision in Y direction during the exposure.

When he exposure apparatus or exposure method of the present invention is adopted in the exposure of the substrates, the substrates can be positioned with high precision during the exposure. Therefore, the pattern can be exposed with high precision, and thus a high quality substrate can be manufactured.

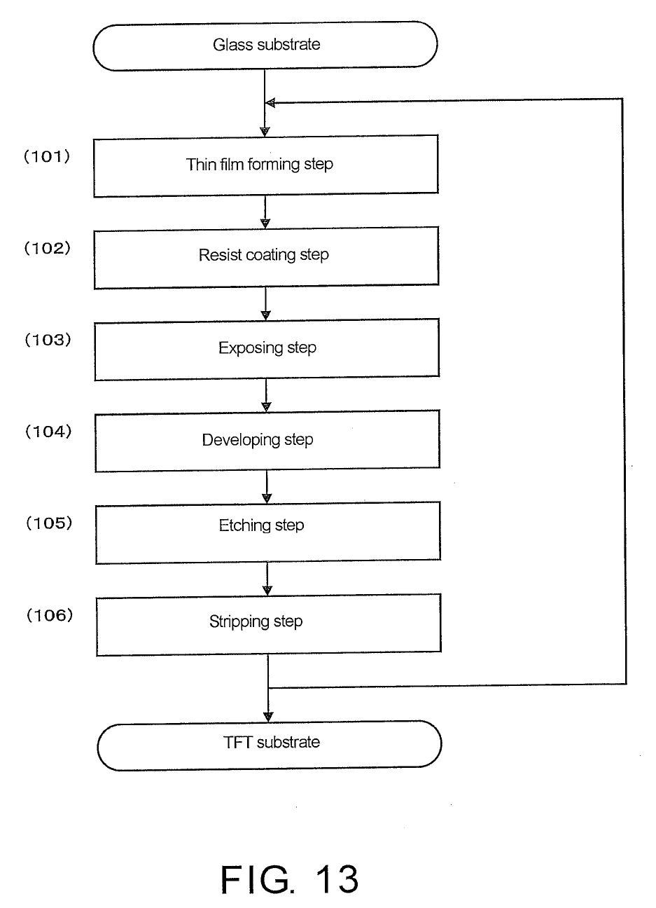

For example, FIG. 13 is a flow chart of steps for manufacturing TFT substrates of liquid crystal display devices according to an embodiment of the present invention. In a thin film forming step (step 101), a thin film used as a conductive film, insulating film, or the like of a transparent electrode for driving liquid crystals is formed on a substrate by a sputtering process, a plasma chemical vapor deposition (CVD) process, or the like. In a resist-coating step (step 102), a photosensitive resin material (photo-resist) is coated by a roller-coating process or the like so as to form a photo-resist layer on the thin film formed in the thin film forming step (step 101). In an exposing step (step 103), the pattern of the mask is transferred onto the photo-resist layer by the use of a proximity exposure apparatus, projection exposure apparatus, or the like. In a developing step (step 104), a developing solution is supplied onto the photo-resist layer by a shower developing process or the like so as to remove an extra part of the photo-resist layer. In an etching step (step 105), a portion, which is not shielded by the photo-resist layer, of the thin film formed in the thin film forming step (step 101) is removed through wet-etching. In a stripping step (step 106), the photo-resist layer used as the mask in the etching step (step 105) is stripped by a stripping solution. A cleaning/drying step may be carried out on the substrates before or after the above steps according to the practical requirements. These steps are repeated for several times, and thus a TFT array is formed on the substrate.

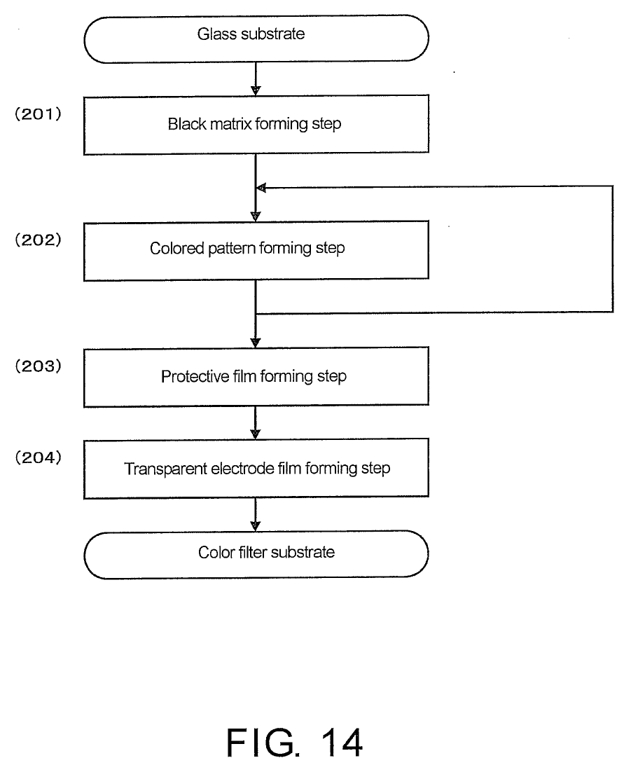

FIG. 14 is a flow chart of steps for manufacturing color filter substrates of liquid crystal display devices. Referring to FIG. 14, in a black matrix forming step (step 201), the black matrix is formed on a substrate by a resist-coating, exposing, developing, etching, stripping, or other treatments. In a colored pattern forming step (step 202), the colored pattern is formed on the substrate by a dyeing, pigment dispersion, printing, electroplating, or other processes. A Red (R), green (G), or blue (B) colored pattern can be formed by repeating the above steps. In a protective film forming step (step 203), the protective film is formed on the colored pattern. In a transparent electrode film forming step (step 204), the transparent electrode film is formed on the protective film. A cleaning/drying step may be carried out on the substrates before, during, or after the above steps according to actual requirements.

In the steps for manufacturing TFT substrates as shown in FIG. 13, the exposure apparatus or exposure method of the present invention is applicable to the exposing step (step 103). In the steps for manufacturing the color filter substrates as shown in FIG. 14, the exposure apparatus or exposure method of the present invention is applicable in the exposing treatment of the black matrix forming step (step 201).

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An exposure apparatus, using a proximity mode, comprising:
a plurality of chucks, for holding substrates;
a mask holder, for holding a photo-mask;
a primary stage base, arranged below the mask holder;
a plurality of secondary stage bases, arranged adjacent to one another in X direction (or Y direction) of the primary stage base;
guide rails, extending from the primary stage base to the plurality of secondary stage bases;
a plurality of movable stages, each comprising a first stage, a second stage, and a third stage, wherein the first stages are carried on the guide rails and move in X direction (or Y direction), the second stages are carried on the first stages and move in Y direction (or X direction), the third stages are carried on the second stages and rotate in θ direction, and the movable stages carry the chucks and move towards one secondary stage base and the primary stage base, thereby positioning the substrates on the primary stage base;
a plurality of first laser length-measuring systems, for detecting positions of the movable stages in X direction (or Y direction);
a plurality of stage driving circuits, for driving the movable stages, and a control device, for controlling the stage driving circuits,
wherein each of the first laser length-measuring systems comprises a light source for generating a laser, a reflection mirror mounted below the first stages of the movable stages, and a laser interferometer disposed at positions deviated from the guide rails on the primary stage base so as to measure interference of a laser from a light source and a laser reflected by the reflection mirror, and
wherein the control device controls the stage driving circuits according to detection results of the first laser length-measuring systems.

2. The exposure apparatus according to claim 1, wherein each first laser length-measuring system has a number of laser interferometers, and the laser interferometers are disposed at positions deviated from the guide rails on the primary stage base.

3. The exposure apparatus according to claim 1, comprising:
a stage, mounted in Y direction (or X direction) of the primary stage base; and
a second laser length-measuring system, for detecting positions of the movable stages in Y direction (or X direction) on the primary stage base;
wherein the second laser length-measuring system comprises a light source for generating a laser, reflection mirrors mounted on the second stages of the movable stages, and a laser interferometer disposed on the stage pedestal so as to measure interference of the laser from the light source and a laser reflected by the reflection mirrors, and
wherein the control device controls the stage driving circuits according to a detection result of the second laser length-measuring system.

4. The exposure apparatus according to claim 3, wherein the reflection mirrors of the second laser length-measuring system are mounted substantially at a height of the chucks carried by the movable stages.

5. The exposure apparatus according to claim 1, comprising:
reflection mirrors, mounted on the chucks;
a plurality of laser displacement meters, disposed corresponding to the chucks, for measuring displacement of the reflection mirrors; and
a tilt detection mechanism, for detecting tilt of the chucks in θ direction according to measurement results of the plurality of laser displacement meters,
wherein the control device controls the stage driving circuits according to a detection result of the tilt detection mechanism.

6. The exposure apparatus according to claim 5, wherein the plurality of laser displacement meters is disposed on the first stages of the movable stages.

7. An exposure method, using a proximity mode, comprising:
arranging a primary stage base below a mask holder holding a photo-mask;
arranging a plurality of secondary stage bases adjacent to one another in X direction (or Y direction) of the primary stage base;
disposing guide rails extending from the primary stage base to the plurality of secondary stage bases;
disposing a plurality of movable stages, wherein each movable stage comprises a first stage, a second stage, and a third stage, the first stages are carried on the guide rails and move in X direction (or Y direction), the second stages are carried on the first stages and move in Y direction (or X direction), the third stages are carried on the second stages and rotate in θ direction, and the plurality of movable stages carry chucks that hold substrates;
moving the movable stages towards one secondary stage base and the primary stage base,
positioning the substrates on the primary stage base by the use of the movable stages;
using a plurality of first laser length-measuring systems, wherein each of the first laser length-measuring systems comprises a light source for generating a laser, a reflection mirror mounted on the movable stages, and a laser interferometer for measuring interference of a laser from a light source and a laser reflected by the reflection mirror, the reflection mirrors are mounted below the first stages of the movable stages and the laser interferometers are disposed at positions deviated from the guide rails on the primary stage base so as to detect positions of the movable stages in X direction (or Y direction); and
controlling the substrate positioning performed by the movable stages according to a detection result.

8. The exposure method according to claim 7, wherein in each first laser length-measuring system, a plurality of laser interferometers is disposed at positions deviated from the guide rails on the primary stage base.

9. The exposure method according to claim 7, comprising:
mounting a stage in Y direction (or X direction) of the primary stage base; and
using a second laser length-measuring system, wherein the second laser length-measuring system comprises a light source for generating a laser, reflection mirrors mounted on the movable stages, and a laser interferometer for measuring interference of the laser from the light source and a laser reflected by the reflection mirrors, the reflection mirrors are mounted on the second stages of the movable stages and the laser interferometer is disposed on the stage so as to detect positions of the movable stages in Y direction (or X direction) on the primary stage base; and
controlling the substrate positioning performed by the movable stages according to a detection result.

10. The exposure method according to claim 9, wherein the reflection mirrors of the second laser length-measuring system are mounted substantially at a height of the chucks carried by the movable stages.

11. The exposure method according to claim 7, comprising:
mounting reflection mirrors on the chucks;
using a plurality of laser displacement meters to measure displacement of the reflection mirrors respectively, so as to detect tilt of the chucks in θ direction, controlling the substrate positioning performed by the movable stages according to a detection result.

12. The exposure method according to claim 11, wherein the plurality of laser displacement meters is disposed on the first stages of the movable stages.

13. A method for manufacturing a display panel substrate, wherein an exposure apparatus according to claim 1 is used to expose a substrate.

14. A method for manufacturing a display panel substrate, wherein an exposure method according to claim 7 is used to expose a substrate.
